(19) United States
(12) Patent Application Publication
(10) Pub. No.: US 2008/0258910 A1
(43) Pub. Date: Oct. 23, 2008

(54) Student And Faculty Emergency Response System (SAFERS)

(76) Inventor: Scott Stapleford, Londonderry, NH (US)

Correspondence Address: SCOTT STAPLEFORD, 17 HARDY ROAD, LONDONDERRY, NH, 03053, US

(21) Appl. No.: 11/737,861

(22) Filed: Apr. 20, 2007

(51) Int. Cl. G08B 21/00

(52) U.S. Cl. 340/540

(57) ABSTRACT

An emergency response system that is used by schools to alert students, faculty, and staff on the school campus of critical situations. The system utilizes ID cards that are issued to the students, faculty, and staff at the beginning of each new school year, and issued to visitors as needed. The ID cards each have a miniature receiver, control circuitry, antenna and battery embedded into them along with a flat speaker and an LED light. If an emergency on the grounds of the school is imminent or ongoing, a master transmitter box is triggered by an administrator. The triggering of the transmitter sends coded RF signals out to ID cards and repeaters that are strategically placed through the school property. Signals received by the receivers embedded into the ID cards and decoded by the control circuitry trigger the speaker and LED in the ID cards to alert persons carrying the ID cards.

### BACKGROUND OF INVENTION

In the prior art alerts or notice of emergencies have been initiated by authorized personnel and have been disseminated to segments of the populace using radio, television, sirens, Internet, telephone and pagers. However, these modes of disseminating alerts or notice of emergencies are generally not received by the segments of the populace to whom they are disseminated because they are not listening to the radio or not to the proper radio station at the time an alert is disseminated, because they are not listening to the radio or not to the proper radio station at the time an alert is disseminated, and so on. By the time the people in the desired segment of the populace receive an alert or notice it is typically too late. This is particularly true for tornados and alerts regarding ongoing activities of terrorists or other criminals.

The problem described in the previous paragraph is true at most colleges and schools there is no single way to communicate alerts and notices of emergencies effectively to students, faculty, staff and visitors in multi-building or large campus layouts.

Thus, there is a need in the prior art for a way to rapidly and effectively communicate alerts or notice of emergencies initiated by authorized personnel to segments of the population, particularly in locations such school campuses.

### SUMMARY OF INVENTION

To meet the aforementioned need in the prior art to rapidly and effectively communicate alerts or notice of emergencies to segments of the population, particularly in locations such school campuses, an Emergency Response Systems (ERS) is described that utilizes items that are commonly carried by people. In the setting of a school campus the ERS system would utilize the singular item that is common to most school environments which is the student and faculty ID card. The ID card used in the ERS system has an embedded RF receiver that can only be activated by designated officials at the college or school in an emergency by utilizing a transmitter, and repeaters as necessary, to transmit alert and notice signals to designated students and faculty. The designated students and faculty may be all or a subset of all of them. In addition, different alerts may be transmitted to different people carrying the ID cards with RF receiver embedded therein. For example, students may receive one alert and faculty and / or staff may receive different types of alerts. This would notify students, faculty and staff to take action based upon the type of alert they each receive.

In a governmental setting where all people typically carry an ID card, the carriers of such ID cards can receive designated transmitted alerts and notices. Key higher up people may receive one type of alert and other people may receive different alerts.

This solves the current problem of trying to use too many different forms of communication such as text messaging, cell phones, email, etc. The other issue this system solves is since it is all battery operated is it would not depend upon land line power which would make existing public address systems unusable.

### BRIEF DESCRIPTION OF THE DRAWING

The invention will be better understood upon reading the following Detailed Description in conjunction with the Drawing in which:

FIG. 1 illustrates the front side of a student or staff ID card on which is typically displayed a picture, name and other information of the person to whom the card is issued, and showing holes for sound emitting from a small, flat speaker embedded in the card, and a clear area for light being emitted by an LED embedded in the card;

FIG. 2 shows a cutaway of the student, faculty and staff ID card showing an antenna, battery, integrated circuit receiver and control circuitry, a flat speaker and an LED for audibly and visibly communicating alerts;

FIG. 3 illustrates the back side of a student, faculty or staff ID card having a magnetic strip containing personal information about the carrier of the ID card, and having printed thereon at least instructions to be followed when different types of alert signals and notices are received by the circuitry embedded in the ID card and visual and audible signals are generated;

FIG. 4 illustrates an RF repeater module for re-transmitting alert signals to assure coverage at all location in a defined area where alert signals and notices are to be received; and

FIG. 5 illustrates a transmitter module from which authorized individuals may cause alert signals to be transmitted.

### DETAILED DESCRIPTION

In the following description the invention is described with reference to use with student, faculty and staff ID cards, but the invention may be used in other ID cards used by companies, government agencies etc.

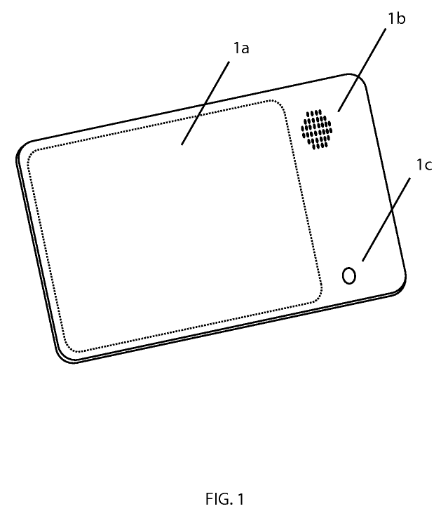

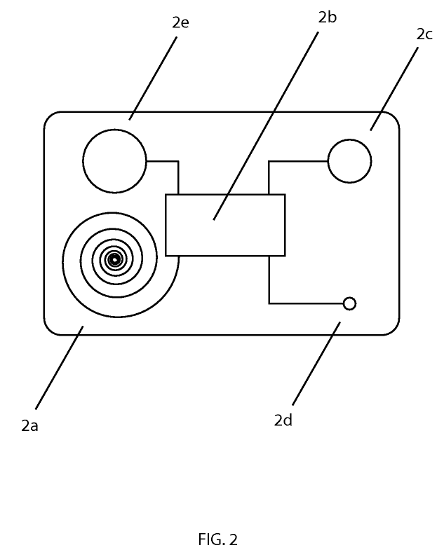

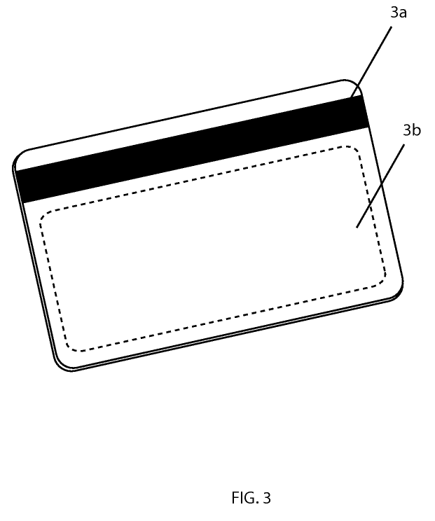

Students or faculty checking in at the beginning of each new school year are typically issued a new ID card identifying the school year. FIG. 1 shows the front side of a blank ID card. An ID card would typically be 3.40″×2.10″×0.050″ (L×H×W) in size. After a photograph is taken, it and other information such as bearer's name and other pertinent information is printed using ink jet or other printing technology on the front of the card in a specific area 1a. Other private information such as social security number, phone number, medical information, etc. could be encoded into a magnet strip on the rear of the card 3a which is shown in and described with reference to FIG. 3. At location 1b is a number of small holes that allow sound produced by an embedded speaker 2e (see FIG. 2) to pass through the card. At location 1c is a small clear lens area that allows light generated by an embedded LED 2d (See FIG. 2) to pass through.

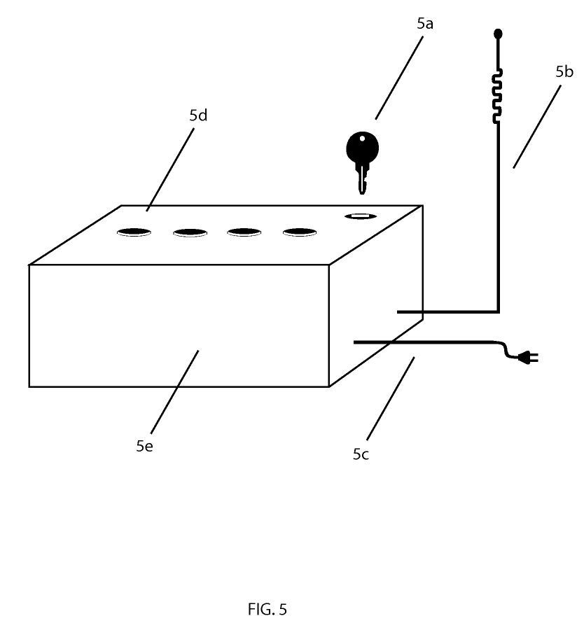

FIG. 2 shows a cutaway view of the interior of a student, faculty or staff ID card showing the details of the present invention. There is a coiled antenna 2a, integrated circuit receiver and control circuitry 2b, flat speaker 2c, LED 2d, and a flat battery 2e. Signals transmitted by transmitter module 5e, which is shown in and described with reference to FIG. 5, are received by antenna 2a and an RF receiver portion of integrated circuit module 2b. Module 2b receives power to operate from battery 2e which will last for at least one year. As battery technology improves this period of time will lengthen. When an alert or notice of emergency is transmitted by transmitter module 5e in FIG. 5, the signal is received and decoded by the control portion of integrated circuit receiver and control circuitry 2b. The control circuitry causes LED 2d to be lit and sound to be generated by flat speaker 2c to alert the person bearing the ID card.

The signal broadcast by transmitter module 5e may be encoded for different alerts and notices, as represented by the different buttons on module 5e, and the circuitry of the control circuitry in module 2b may be designed to only respond to particular encoded transmissions from transmitter module 5e. In this manner different alert signals and notices may be transmitted, addressing different types of alerts and notices, and different signals may be sent to and received by students, faculty and staff.

FIG. 3 shows the back side of a student, faculty or staff ID card having a magnetic stripe 3a thereon. The magnetic stripe 3a is used to record personal information, which may include biographic information, about the carrier of the ID card. There is also an area in which other information is printed. This other information includes at least instructions to be followed when different types of alert signal and notices are received by the receiver and control circuitry embedded in the ID card. When a coded signal is received by an ID card, a coded audible and visible signal are generated, and the code is looked up on the back of the card to determine what the bearer of the ID card is to do in response to the alert or notice.

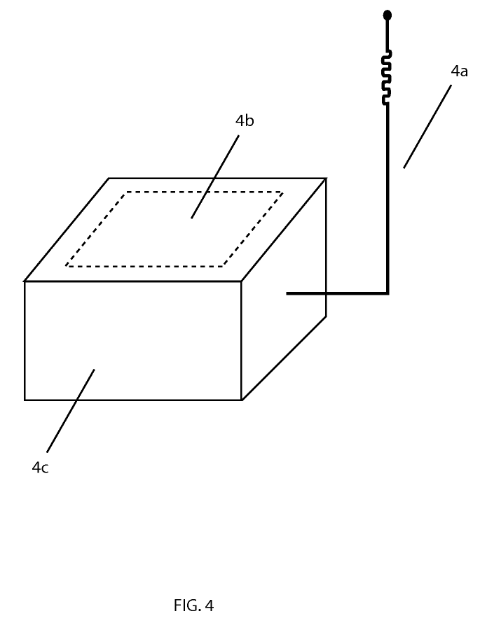

FIG. 4 shows an RF repeater module 4c for re-transmitting alert signals and notices of emergencies transmitted by transmitter module 5e. There are typically locations inside and outside buildings in which RF signals may not be directly received from transmitter module 5e. RF repeater modules 4c are strategically placed to receive alert signals and notice of emergency transmissions from transmitter module 5e and retransmit them to assure signal coverage at all locations in a defined area where alert signals and notice of emergency transmissions are to be received, including inside buildings. The RF repeater modules 4c would be placed throughout the property of the college or school in locations such as on the tops of buildings, inside buildings, on trees, flagpoles, etc. to accomplish this purpose.

An RF repeater module 4c is typically 2.00 inches square, has an antenna 4a, and a solar panel 4b on its side. AC power and a rechargeable battery may also be utilized. The main cube of module 4c holds a transceiver chip and a rechargeable battery (not shown). Solar panel 4b is used to keep battery charged.

FIG. 5 shows a transmitter module 5e from which authorized individuals may cause alert signals and notices of emergencies to be transmitted. The transmitter module 5e would be placed in a secure location that is only available to the security staff or person in charge or sending out an alert signal or notice of emergency. Transmitter module 5e would be plugged into main line power (not shown) using the power cord 5c. Transmitter module 5e has a built-in rechargeable battery back-up (not shown) in case of power loss. The battery is kept charged while there is electrical power on power cord 5c.

Transmitter module 5e is typically in the order of 5.00″×4.00″×1.5″ (L×H×W) in size. There is a master key 5a that is used to turn on module 5e to transmit an alert or notice of emergency. Transmitter module 5e has an antenna 5b that broadcasts the alerts and notices. Module 5e has a number of buttons that are pressed after key 5a is turned on to transmit different alerts and notices.

During an emergency or other event the ERS system would be operated in the following manner. The transmitter module 5e (FIG. 5) is enabled by inserting a master key 5a into the slot on top of module 5e. Once armed any one of four buttons 5d are pressed for a specific type of alert or emergency signal to be transmitted. Once the button(s) are pressed the alert signals or notices of emergency are transmitted via antenna 5b and broadcast directly to ID cards and to the repeaters 4c shown in FIG. 4 for re-transmission to other ID cards.

When a student, faculty or staff ID card receives an alert signal or notice of emergency signal via its embedded antenna 2a, the signal is sent to the receiver and control chip 2b. The received signal is forwarded to the control portion of chip 2b which determines if it is a valid signal. If the signal is valid the control portion of chip 2b causes embedded speaker 2c to beep and LED 2d to flash a number of times depending upon the specific alert signal or notice of emergency transmitted to the ID card. Faculty or staff ID cards may be receive signals that cannot be received by student ID cards.

Once the transmitter module 5e is disarmed using master key 5a the alert signal or notice of emergency signal will cease broadcasting.

While what has been described herein is a preferred embodiment of the invention numerous changes may be made without departing from the spirit and scope of the invention.

What is claimed is:

1. (canceled)

2. (canceled)

3. (canceled)

4. A wireless emergency response system that transmits selected alerts and notices from a central transmitter to mobile receivers carried by individuals, the system comprising:
a central transmitter from which the selected alerts and notices are transmitted;
a plurality of relatively thin multi-layer cards that are personal to and carried by a like plurality of individuals;
a wireless receiver embedded in one of the layers of the multi-layer cards to receive notices transmitted by the central transmitter;
control circuitry embedded in one of the layers of the multi-layer cards, the control circuitry being responsive to alerts and notices transmitted by the central transmitter and received by the wireless receiver; and
means embedded in one of the layers of the multi-layer cards that is enabled by the control circuitry to provide an indication to the individual carrying a card that an alert or notice has been transmitted by the central transmitter;

5. The wireless emergency response system of claim 4 further comprising at least one transceiver that receives alerts and notices transmitted by the central transmitter and retransmits them to be received by the wireless receivers embedded in the multi-layer cards.

6. The wireless emergency response system of claim 4 wherein the means to provide an indication comprises a light emitter embedded in one of the layers of the multi-layer cards to provide a visual indication of a transmitted alert or notice that is determined by the control circuitry to be intended for the particular card.

7. The wireless emergency response system of claim 4 wherein the means to provide an indication comprises a sound transducer embedded in one of the layers of the multi-layer cards to provide an audible indication of a transmitted alert or notice that is determined by the control circuitry to be intended for the particular card.

8. The wireless emergency response system of claim 4 further comprising an antenna embedded in one of the layers of the card that is connected to the wireless receiver to facilitate receiving an alert or notice transmitted by the central transmitter.

9. The wireless emergency response system of claim 4 further comprising a battery embedded in the one of the layers of the card that provides power to the wireless receiver, control circuitry and means to provide an indication.

10. The wireless emergency response system of claim 4 wherein different ones of a number of the alerts and notices may be transmitted by the central transmitter and the control circuitry embedded in each card will only respond to certain ones of the different transmitted alerts and notices to enable the means to provide an indication that an alert or notice has been transmitted by the central transmitter.

11. The wireless emergency response system of claim 10 wherein the means to provide an indication comprises a sound transducer embedded in one of the layers of the multi-layer cards to provide an audible indication of a transmitted alert or notice that is determined by the control circuitry to be intended for the particular card.

12. The wireless emergency response system of claim 11 wherein the means to provide an indication comprises a light emitter embedded in one of the layers of the multi-layer cards to provide a visual indication of a transmitted alert or notice that is determined by the control circuitry to be intended for the particular card.

13. The wireless emergency response system of claim 12 further comprising an antenna embedded in one of the layers of the card that is connected to the wireless receiver to facilitate receiving an alert or notice transmitted by the central transmitter.

14. The wireless emergency response system of claim 13 further comprising a battery embedded in the one of the layers of the card that provides power to the wireless receiver, control circuitry and means to provide an indication.

15. The wireless emergency response system of claim 14 further comprising at least one transceiver that receives alerts and notices transmitted by the central transmitter and retransmits them to be received by the wireless receivers embedded in the multi-layer cards.

16. The wireless emergency response system of claim 3 wherein the multi-layer cards are identity cards carried by students, faculty and employees on a school campus.

17. A method for transmitting selected alerts and notices from a central transmitter to mobile receivers carried by individuals, the method comprising the steps of:
embedding a wireless receiver and control circuitry in each of a plurality of relatively thin multi-layer cards that are personal to and carried by individuals;
receiving alerts and notices transmitted by the central transmitter with the wireless receiver and control circuitry embedded in the multi-layer cards;
providing an indication to one or more individuals carrying the cards that an alert or notice has been transmitted by the central transmitter.

18. The method for transmitting selected alerts and notices from a central transmitter to mobile receivers carried by individuals in accordance with claim 17, further comprising the step of receiving alerts and notices transmitted from a central transmitter and re-transmitting them to assure that the alerts and notices are received by the wireless receiver and control circuitry embedded in the multi-layer cards.

19. The method for transmitting selected alerts and notices from a central transmitter to mobile receivers carried by individuals in accordance with claim 18 further comprising the step of transmitting different notices and alerts depending on the nature of an event indicated by the notices and alerts.

20. The method for transmitting selected alerts and notices from a central transmitter to mobile receivers carried by individuals in accordance with claim 19 further comprising the steps of:
embedding an antenna in each of a plurality of relatively thin multi-layer cards that are personal to and carried by individuals, the antenna in each card being connected to the wireless receiver embedded therein; and
embedding a battery in each of a plurality of relatively thin multi-layer cards that are personal to and carried by individuals, the battery in each card providing electrical power to the wireless receiver and control circuitry also embedded therein.
